(19) United States
(12) Patent Application Publication
(10) Pub. No.: US 2025/0265125 A1
(43) Pub. Date: Aug. 21, 2025

(54) TECHNOLOGIES FOR LOAD BALANCING DATA PROCESSING

(71) Applicant: Intel Corporation, Santa Clara, CA (US)

(72) Inventors: Jiaqi LOU, Urbana, IL (US); Ren WANG, Portland, OR (US)

(21) Appl. No.: 19/178,078

(22) Filed: Apr. 14, 2025

(51) Int. Cl. G06F 9/50

(52) U.S. Cl. CPC G06F 9/505

(57) ABSTRACT

Examples described herein relate to circuitry to select a first load balancer from among multiple load balancers to allocate a packet to a processor core among multiple processor cores of a processor and change from the first load balancer to select a second load balancer among the multiple load balancers based on a change in load metrics. In some examples, the multiple load balancers include at least: a load balancer that selects a processor core among the multiple processor cores based on a hash calculation on packet content and a load balancer that load balances among the multiple processor cores based on the load metrics.

Data centers provide processing, storage, and networking resources for customers. For example, automobiles, smart phones, laptops, tablet computers, or internet of things (IoT) devices can leverage data centers to perform data analysis, data storage, or data retrieval. Data centers include processors and devices such as memory, accelerators, network interface devices, and others.

Networks provide connectivity among multiple processors, memory devices, and storage devices for distributed performance of processes. Cloud service providers and datacenters have adopted network interface devices with ever increasing rates of packet transport. Processors process the packets received by network interface devices. However, packets may overrun processing capabilities of processors, which can lead to packet drops or slow the processing rate of packets.

### BRIEF DESCRIPTION OF THE DRAWINGS

FIG. 1 depicts an example system.

FIG. 2 depicts an example operation of a system.

FIG. 3 depicts an example process.

FIG. 4 depicts an example of operations.

FIG. 5 depicts an example process.

FIG. 6 depicts an example computing system.

### DETAILED DESCRIPTION

To attempt to prevent overloading a processor core, incoming packets can be load balanced among multiple processor cores. A single load balancer may not handle different network conditions appropriately, thus degrading packet processing throughput. Various examples described herein can select from among different load balancers based on telemetry data. Telemetry data can include at least: rate of packet receipt (RX), load balancer queue depth or occupancy level, and processor utilization or service time of operations (e.g., time stamp packet of receipt in queue compared to time stamp of RX packet when completed processed by core). Various examples can perform adaptive load balancing to process network workloads among multiple central processing unit (CPU) cores based on different network traffic conditions. For example, load balancers can include at least: a first load balancer that selects cores based on a hash calculation, a second load balancer performed by a processor-executed process and that selects a processor core based on telemetry data, and a third load balancer implemented as an accelerator and that selects a processor core based on telemetry data. For example, load balancers can include at least: receive side scaling (RSS), processor executed load balancing, or hardware-based load balancer. Adaptive load balancing can dynamically determine which load balancer to utilize at runtime under different network conditions to attempt to improve throughput of processing packets, increase energy efficiency, and increase load balancing efficiency.

For example, for approximately constant or level amount of packet processing and packet receive rate at or below a first level, a hash-based load balancing or processor-executed load balancer that selects a processor core based on telemetry. At packet receive rates that exceed a second level, that is higher than the first level, and based on varying received packet traffic patterns, various examples can dynamically transition from use of RSS or a software-based load balancer to an load balancer implemented as an accelerator.

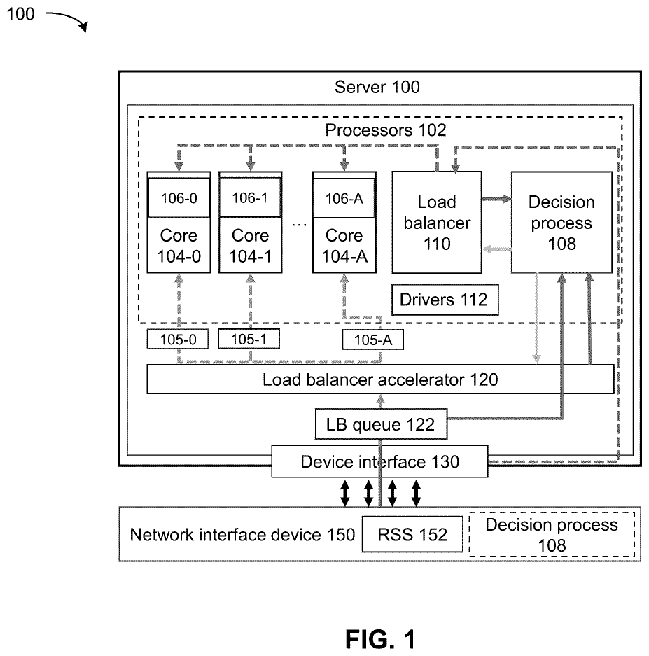

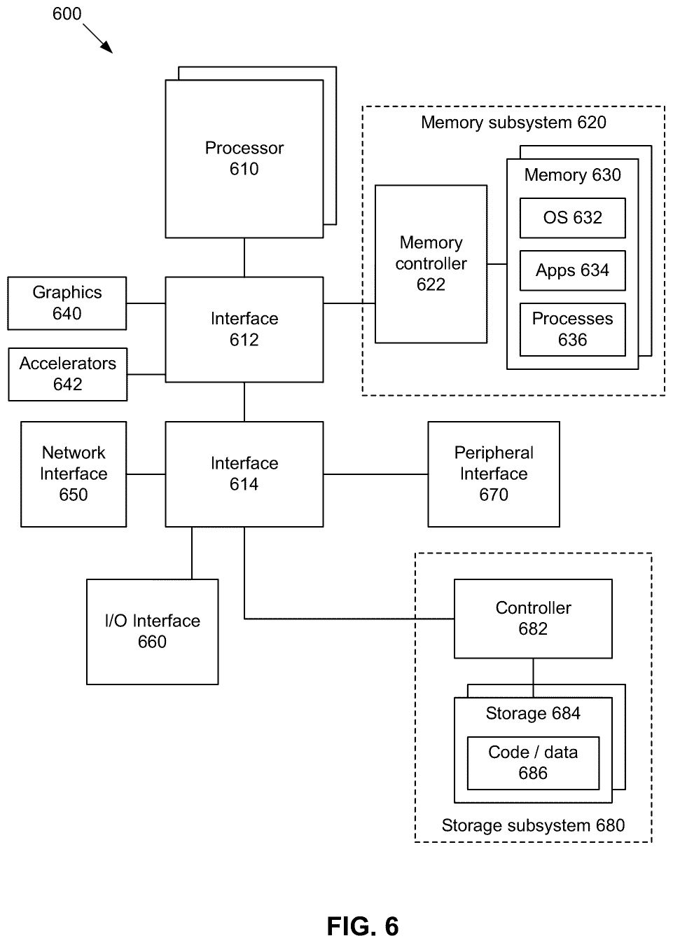

FIG. 1 depicts an example system. Server 100 can include processors 102, load balancer accelerator 120, device interface 130, and other circuitry and software described with respect to FIG. 6. For example, processors 102 and worker cores 104-0 to 104-A, where A is an integer, can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), accelerator, tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Accelerator cores, slices, and/or cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Worker cores 104-0 to 104-A can at least execute processes 106-0 to 106-A, decision process 108, load balancer 110, and drivers 112. Processes 106-0 to 106-A can include one or more of: application, process, thread, a virtual machine (VM), microVM, container, microservice, or other virtualized execution environment. Various examples of processes 106-0 to 106-A can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV MANO from ETSI's Open Source Mano (OSM) group. Processes 106-0 to 106-A can include virtual network function (VNF), such as a service chain or sequence of virtualized tasks executed on generic configurable hardware such as firewalls, domain name system (DNS), caching or network address translation (NAT) and can run in virtual execution environments. VNFs can be linked together as a service chain. Processes 106-0 to 106-A can include a cloud native network function (CNF), which can include a network function that executes inside a container. In some examples, EPC is a 3GPP-specified core architecture at least for Long Term Evolution (LTE) access. 5G network slicing can provide for multiplexing of virtualized and independent logical networks on the same physical network infrastructure. Processes 106-0 to 106-A can perform video processing or media transcoding (e.g., changing the encoding of audio, image or video files).

As described herein, at run time during receipt and processing of packets by processes 106-0 to 106-A, decision process 108 can select a load balancer based on telemetry data and/or packet flow priority level. For example, decision process 108 can select a load balancer at least from among load balancer 110, load balancer 120, or receive side scaling (RSS) 152. In some examples, decision process 108 can be implemented as a process executed by a core of processors 104, or as a processor-executed process or circuitry of network interface device 150. Decision process 108 can execute as a user space background daemon, kernel space, or firmware. Decision process 108 can be plugged into an application with application programming interfaces (APIs) during initialization.

For example, telemetry can include one or more of: core utilization levels, queue levels of load balancer queue 122; average packet receive rate over a time period; increase or decrease in packet receive rate relative to the average packet receive rate; packet flow telemetry; workload data; or others. For example, core utilization levels can include: a number of active threads, active cycles over a time period, complexity of the task or workload, current processing load, percentage of time a core is performing operations, or other indicators of busyness. For example, load balancer queue 122 can include one or more queues allocated to store packets that are to be load balanced. For example, a core can report core utilization to decision process 108. For example, decision process 108 can monitor queue levels 105-0 to 105-A in memory allocated as inputs to cores. For example, network interface device 150 can utilize counters to count received packets and report packet receive rate telemetry data to decision process 108. Workload data can include packet receipt traffic patterns and packet receive rate for various workloads based on prior executions of a particular workload or process. Workload data can specify operation service times and its packet distribution across cores using hash-based distribution of packets to cores. For example, processing Hypertext Transfer Protocol (HTTP) traffic may involve a relatively low packet receive rate for a flow and approximately even receive rate of packets using hash-based distribution of packets to cores.

A packet may be used herein to refer to various formatted collections of bits that may be sent across a network, such as Ethernet frames, IP packets, Transmission Control Protocol (TCP) segments, User Datagram Protocol (UDP) datagrams, etc. A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

For example, distribution of packets across cores using a hash function of a header field for a flow (e.g., RSS 152), can be applied based on: packet processing workloads being uniformly distributed across cores as indicated on core utilization or service time (e.g., latency of processing packet) being approximately the same, and packet receipt rates being approximately constant over time. In some examples, RSS can be performed by a processor-executed process based on Microsoft® Windows® or Linux. Network interface device 150 can perform RSS 152 to distribute packets to different cores based on a hash calculation on packet headers. For example, input fields to a hash calculation can include source media access control (MAC) address, destination MAC address, source Internet Protocol (IP) address, destination IP address, or others. The RSS hash can utilize a 40 or 52 byte key to distribute packets over receive queues. A hash operation can include XOR hash function or Toeplitz Hash Function. Network interface device 150 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

For example, for relatively consistent packet receive rate and for a packet receive rate that is less than or equal to a first packet receive rate level, decision process 108 can select load balancer 110 to perform load balancing based on telemetry data as well as packet flow priority. For example, load balancer 110 can allocate the packet to a queue allocated to a core where the core utilization level is less than a first core utilization level. For example, load balancer 110 can allocate a high priority received packet, to a queue allocated to a core where the core utilization level is less than a second core utilization level, which is less than the first core utilization level. Load balancer 110 can be executed on a core that performs processing of packets or one or more cores that solely perform load balancing operations to allocate packets to cores.

For bursty or high packet rate network conditions relative to an average packet receive rate or packet receive rates that are higher than the first packet receive rate, decision process 106 can select load balancer 120 to perform load balancing of received packets based on telemetry data as well as packet priority. Hardware-based dynamic load balancer 120 can load balance the incoming packets to worker cores at a higher packet rate at lower latency than load balancer 110. Load balancer 120 can be implemented in network interface device 150 in some examples. An example of load balancer 120 includes Intel® Dynamic Load Balancer (DLB) or a load balancer implemented as a field programmable gate array (FPGA) or application specific integrated circuit (ASIC).

In some examples, based on a change to stopping use of RSS 152, decision process 106 can disable use of RSS 152 and network interface device 150 can store received packets in load balancer queue 122 for load balancing by the selected load balancer. In some examples, based on a change in selected load balancer, decision process 106 can redirect packets of load balancer queue 122, that were formerly to be load balanced by load balancer 110, to be load balanced by load balancer 120.

Processor-executed drivers 112 can provide processes 106-0 to 106-A with access to load balancer accelerator 120 as well as network interface device 150. For example, accelerator 120 can be accessed as a Peripheral Component Interconnect express (PCIe) device.

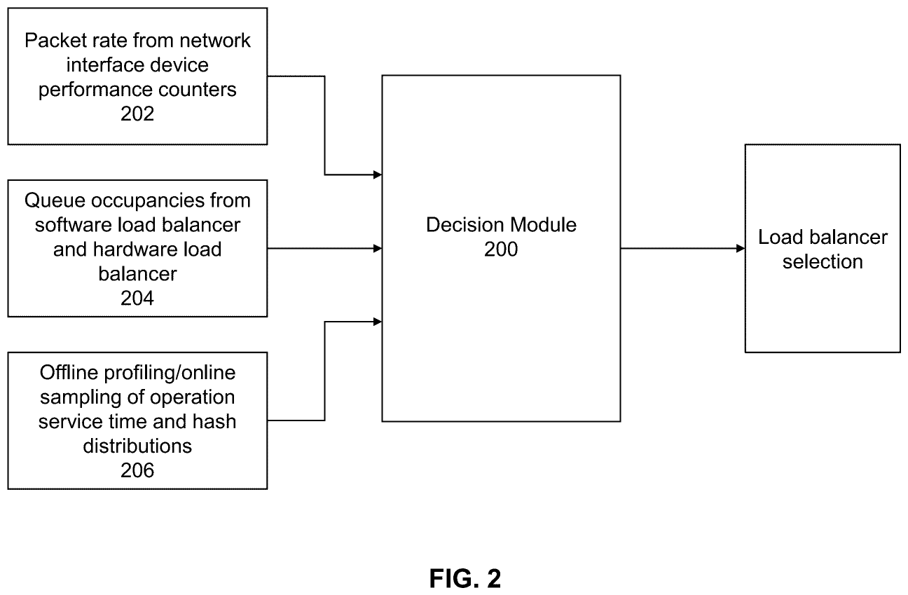

FIG. 2 depicts an example operation of a decision process. Decision process 200 can receive inputs of at least real-time packet rate information 202 from a network interface device, queue occupancy level of packets to be load balanced 204, and processing times of packet processing requests based on historic executions of packet processing operations by cores based on hash distributions of packets to cores 206. For 202, network interface device can utilize performance counters to measure and report packet receive rate. For 204, software load balancer can measure queue occupancy for load balancers and periodically report the queue fullness levels of load balancers to decision process 200. Decision process 200 can monitor the hardware load balancer queue occupancies by accessing built-in performance counters. For 206, processing times of requests can be determined based on samples of time spent on processing one or more packet processing requests by worker cores for worker cores selected by hash-based distribution.

With the input information 202-206, decision process 200 can analyze the utilization of the worker cores and load pressure based on the queue occupancies. In addition, runtime sampling of operation service time and hash distributions can be enabled to analyze the incoming packet traffic pattern. Based on offline profiling of historic data center workloads that distribute packets for processing based on the hash results, decision process 200 can determine whether packet processing service times by cores is relatively constant. If the packet processing service times by cores is relatively constant or within X % of an average processing time, where X is a variable set by a data center administrator, decision process 200 can choose hash-based distribution as the load balancer technology to distribute packets to cores. In addition, decision process 200 can select a hash-based distribution of packets to cores for a new flow of received packets.

Based on packet processing service times increasing above the average processing time by X % or more or RX queue lengths of cores having a change of Y % or more, where Y is configured by a data center administrator, and if packet receive rate is less than a first packet receive level, decision process 200 can select a software-based load balancer. Based on packet processing service times increasing above the average processing time by X % or more or RX queue lengths of cores having a change of Y % or more, and if packet receive rate is more than the first packet receive level, decision process 200 can select a hardware-based load balancer. Hardware-based load balancer can be implemented as one or more of: an FPGA, ASIC, or a processor that performs solely a load balancer process.

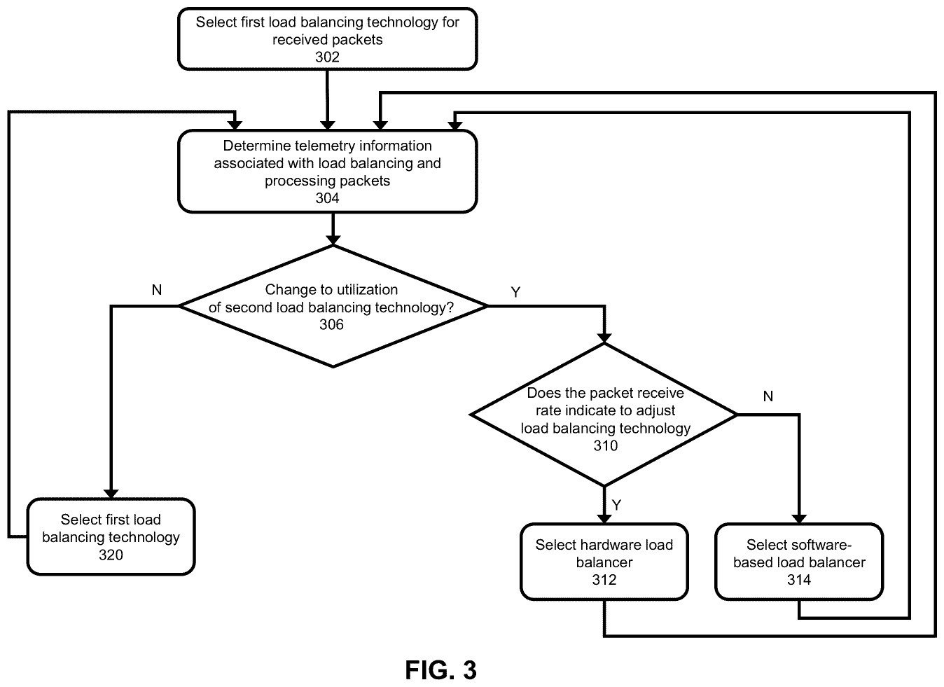

FIG. 3 depicts an example process. The process can be performed by a load balancer selection process or circuitry in some examples. At 302, a first load balancing technology can be selected to distribute received packets among one or more processors for processing. In some examples, the first load balancing technology for initial received packets for a flow can be RSS or other hash based distribution of packets based on packet header content, although other load balancing technologies can be used. At 304, telemetry information associated with load balancing and processing of packets can be determined. For example, telemetry information can include packet receipt rate for packets that are load balanced among one or more processors, queue occupancy levels of multiple load balancers, time to completion or latency of processing packets by one or more processors, packet flow priority, or others.

At 306, a determination can be made of whether to change from the first load balancing technology to a second load balancing technology based on the telemetry information and operating parameters. For example, operating parameters can indicate percentage changes in packet receipt rate for packets that are load balanced among one or more processors, queue occupancy levels of multiple load balancers, time to completion or latency of processing packets by one or more processors, or others. For example, operating parameters can indicate traffic skewness threshold J, which can define how evenly incoming traffic are distributed among cores by RSS or the first load balancer selection. For example, Jain's fairness index J can measure how evenly the incoming traffic is distributed:

$$( x ) = \frac{{( {\sum }_{i = 1}^{n} {x}_{i} )}^{2}}{n {\sum }_{i = 1}^{n} {x}_{i}^{2}}$$

where, xᵢ can present a measurement of queue length or the response time on a core i.

The value of J(x) can be between 1/n to 1, where 1 can represent an even distribution among processors and 1/n can represent a skewed distribution among processors. For example, operating parameters can indicate a guard band of a first level of J (J_first) and a second level of J (J_second). If the rate of received packet traffic stays between J_first and J_second, the current load balancing technology can be retained, however based on J being below J_first for a time duration or exceeding J_second for the time duration, the process can proceed to 310. The time duration can be utilized to reduce oscillation among different load balancer technologies and associated overhead caused by switching load balancer technologies due to transient changes in distribution. In some examples, an average of distribution values over a time window can be measured and compared against J_first and J_second and if the average of distribution values over a time window is below J_first or the average of distribution values over a time window is above J_second, the process can proceed to 310.

At 310, a determination can be made to adjust the load balancing technology based on an average packet receive rate over a time window and first and second packet receive rate parameter values. For example, the average packet receive rate can indicate a packet receipt rate for packets that are load balanced among one or more processors. Based on the average packet receive rate meeting or being below the first packet receive rate parameter value, the process can proceed to 314. Based on the average packet receive rate meeting or being above the second packet receive rate parameter value, the process can proceed to 312.

At 312, the hardware load balancer accelerator can be selected to perform load balancing to provide energy efficient and potentially faster load balancing operations. The hardware load balancer can select a core to process a packet based on load data. Load data can include at least: rate of packet receipt, load balancer queue depth or occupancy level, and processor utilization or service time of operations. At 314, the processor-executed software load balancer can be selected to perform load balancing. The processor-executed software load balancer can select a core to process a packet based on the load data.

While examples are described with respect to selecting processors to process received packets, examples can be applied at least to selecting processors to process any data such as artificial intelligence training data or data for artificial intelligence inference operations (e.g., image recognition, autonomous vehicle navigation data, or others). While examples are described with respect to load balancing processing of packets, examples can apply to any received data, including packet data.

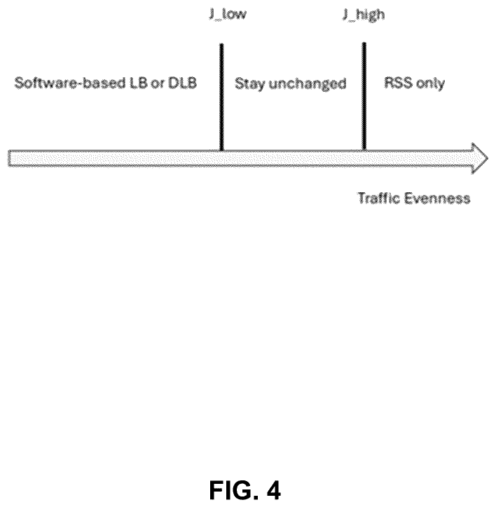

FIG. 4 depicts a guard band mechanism to avoid oscillations among load balancing technologies. In order to avoid system oscillation between different load balancers, a guard band technology can be used. When the distribution of load among cores is approximately even (e.g., J(x) larger than a threshold J_high), a hash-based approach can be selected as a load balancer. When the distribution of load among cores becomes uneven (e.g., J(x) is smaller than a threshold J_low), software-based load balancing or hardware load balancing can be performed. If the distribution of load among cores is between J_low and J_high, a current load balancer can be retained to avoid system oscillation and associated overhead caused by changing load balancers. To further reduce oscillation, a time window can be used over which to measure distribution of load among cores and if distribution of load among cores does not exceed J_low or J_high within the time window, the current load balancer can be retained.

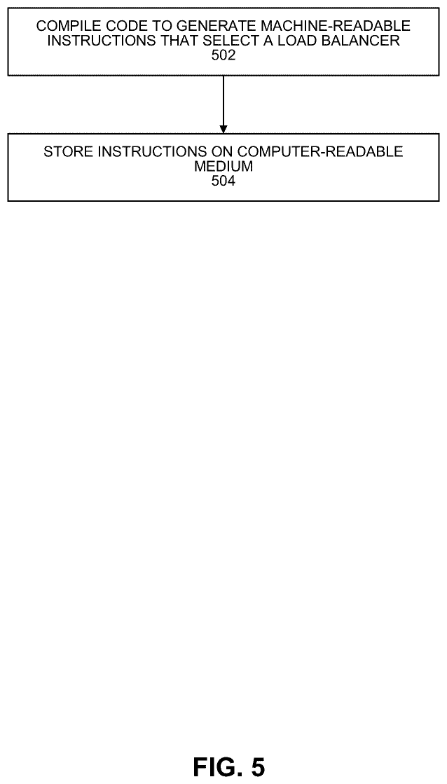

FIG. 5 depicts an example process to make a selector of a load balancer. At 502, source code can be compiled to generate machine-readable instructions. Execution of the machine-readable instructions can cause selection of a load balancing system from among multiple load balancing systems based on processor load, distribution of loads among processors, packet receive rate, data to be processed, packet priority, or other metrics or data. In some examples, the multiple load balancing systems can include: a load balancer based on hash calculation, a load balancer performed by a processor and that load balances based on load metrics, and a load balancer that performs offloaded load balancing among the multiple processor cores and that load balances based on the load metrics. At 504, the machine-readable instructions can be stored on a computer-readable medium for performance by a processor.

FIG. 6 depicts a system. In some examples, a processor (e.g., processor 610, graphics 640, or network interface 650) can select a load balancer from among multiple load balancers, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. For example, accelerators 642 can include a load balancer accelerator or circuitry. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

OS 632 can advertise capability to select a load balancer based on load metrics. For example, OS 632 can call an API to configure use of selection of a load balancer based on the load metrics.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes at least one non-transitory computer-readable medium, comprising instructions stored thereon, that if executed by one or more processors, cause the one or more processors to: select a first load balancer from among multiple load balancers to allocate a packet to a processor core among multiple processor cores of a processor and change from the first load balancer to select a second load balancer among the multiple load balancers based on a change in load metrics, wherein the multiple load balancers comprise at least: a load balancer that selects a processor core among the multiple processor cores based on a hash calculation on packet content and a load balancer that load balances among the multiple processor cores based on the load metrics.

Example 2 includes one or more examples, wherein the load metrics comprise one or more of: packet receive rate, load balancer queue depth, or packet processing duration.

Example 3 includes one or more examples, wherein the load balancer that load balances among the multiple processor cores based on the load metrics comprises processor-executed process or at least one of a field programmable gate array (FPGA) or an application specific integrated circuit (ASIC).

Example 4 includes one or more examples, wherein the load balancer queue depth comprises a number of packets to be allocated to processors cores by at least one of the multiple load balancers.

Example 5 includes one or more examples, wherein the packet processing duration comprises a time to complete processing of packets.

Example 6 includes one or more examples, wherein: the first load balancer comprises the load balancer that selects the processor core among the multiple processor cores based on a hash calculation and the second load balancer comprises the load balancer circuitry that load balances among the multiple processor cores based on the load metrics.

Example 7 includes one or more examples, wherein: the first load balancer comprises a processor-executed load balancer that load balances among the multiple processor cores based on the load metrics and the second load balancer comprises a load balancer circuitry that load balances among the multiple processor cores based on the load metrics.

Example 8 includes one or more examples, wherein the multiple load balancers comprise at least a processor-executed load balancer, receive side scaling (RSS), and load balancer accelerator device.

Example 9 includes one or more examples, and includes a process of making a load balancer selector comprising: compiling source code to generate machine-readable instructions, wherein execution of the machine-readable instructions cause selection of a load balancing system from among multiple load balancing systems based on processor loads, distribution of loads among processors, and packet receive rate, wherein the multiple load balancing systems comprise: a load balancer that selects a processor core among the multiple processor cores based on a hash calculation, a processor-executed load balancer that load balances among the multiple processor cores based on load metrics, and a load balancer circuitry that load balances among the multiple processor cores based on the load metrics.

Example 10 includes one or more examples, and includes the load metrics comprise one or more of: packet receive rate, load balancer queue depth, or packet processing duration.

Example 11 includes one or more examples, and includes the load balancer queue depth comprises a number of packets to be allocated to processors cores by a load balancer, and the packet processing duration comprises a time to complete processing of packets.

Example 12 includes one or more examples, and includes the multiple load balancing systems comprise at least a processor-executed load balancer, receive side scaling (RSS), and load balancer accelerator device.

Example 13 includes one or more examples, and includes the selection of the load balancing system from among multiple load balancing systems is also based on a time window of changes to distribution of load among cores.

Example 14 includes one or more examples, and includes the selection of the load balancing system from among multiple load balancing systems is also based on packet priority.

Example 15 includes one or more examples, and includes an apparatus that includes: a memory that is to store instructions and a processor that is to execute the instructions to: change from a first load balancer among multiple load balancers to select a second load balancer among the multiple load balancers based on a change in load metrics, wherein the multiple load balancers comprise at least: a load balancer that selects a processor core among the multiple processor cores based on a hash calculation, a processor-executed load balancer that load balances among the multiple processor cores based on the load metrics, and a load balancer circuitry that load balances among the multiple processor cores based on the load metrics.

Example 16 includes one or more examples, and includes the second load balancer communicatively coupled to the processor.

Example 17 includes one or more examples, and includes the load metrics comprise one or more of: packet receive rate, load balancer queue depth, or packet processing duration.

Example 18 includes one or more examples, and includes the load balancer queue depth comprises a number of packets to be allocated to processors cores by a load balancer, and the packet processing duration comprises a time to complete processing of packets.

Example 19 includes one or more examples, and includes the first load balancer comprises the load balancer that selects the processor core among the multiple processor cores based on a hash calculation and the second load balancer comprises the processor-executed load balancer that load balances among the multiple processor cores based on the load metrics or the load balancer circuitry that load balances among the multiple processor cores based on the load metrics.

Example 20 includes one or more examples, and includes the first load balancer comprises the processor-executed load balancer that load balances among the multiple processor cores based on the load metrics and the second load balancer comprises the load balancer circuitry that load balances among the multiple processor cores based on the load metrics.

1. At least one non-transitory computer-readable medium, comprising instructions stored thereon, that if executed by one or more processors, cause the one or more processors to:
select a first load balancer from among multiple load balancers to allocate a packet to a processor core among multiple processor cores of a processor and
change from the first load balancer to select a second load balancer among the multiple load balancers based on a change in load metrics, wherein the multiple load balancers comprise at least: a load balancer that selects a processor core among the multiple processor cores based on a hash calculation on packet content and a load balancer that load balances among the multiple processor cores based on the load metrics.

2. The at least one computer-readable medium of claim 1, wherein the load metrics comprise one or more of: packet receive rate, load balancer queue depth, or packet processing duration.

3. The at least one computer-readable medium of claim 2, wherein the load balancer that load balances among the multiple processor cores based on the load metrics comprises processor-executed process or at least one of a field programmable gate array (FPGA) or an application specific integrated circuit (ASIC).

4. The at least one computer-readable medium of claim 2, wherein the load balancer queue depth comprises a number of packets to be allocated to processors cores by at least one of the multiple load balancers.

5. The at least one computer-readable medium of claim 2, wherein the packet processing duration comprises a time to complete processing of packets.

6. The at least one computer-readable medium of claim 1, wherein:
the first load balancer comprises the load balancer that selects the processor core among the multiple processor cores based on a hash calculation and
the second load balancer comprises the load balancer circuitry that load balances among the multiple processor cores based on the load metrics.

7. The at least one computer-readable medium of claim 1, wherein:
the first load balancer comprises a processor-executed load balancer that load balances among the multiple processor cores based on the load metrics and
the second load balancer comprises a load balancer circuitry that load balances among the multiple processor cores based on the load metrics.

8. The at least one computer-readable medium of claim 1, wherein the multiple load balancers comprise at least a processor-executed load balancer, receive side scaling (RSS), and load balancer accelerator device.

9. A process of making a load balancer selector comprising:
compiling source code to generate machine-readable instructions, wherein execution of the machine-readable instructions cause selection of a load balancing system from among multiple load balancing systems based on processor loads, distribution of loads among processors, and packet receive rate, wherein the multiple load balancing systems comprise: a load balancer that selects a processor core among the multiple processor cores based on a hash calculation, a processor-executed load balancer that load balances among the multiple processor cores based on load metrics, and a load balancer circuitry that load balances among the multiple processor cores based on the load metrics.

10. The process of claim 9, wherein the load metrics comprise one or more of: packet receive rate, load balancer queue depth, or packet processing duration.

11. The process of claim 10, wherein:
the load balancer queue depth comprises a number of packets to be allocated to processors cores by a load balancer, and
the packet processing duration comprises a time to complete processing of packets.

12. The process of claim 9, wherein the multiple load balancing systems comprise at least a processor-executed load balancer, receive side scaling (RSS), and load balancer accelerator device.

13. The process of claim 9, wherein the selection of the load balancing system from among multiple load balancing systems is also based on a time window of changes to distribution of load among cores.

14. The process of claim 9, wherein the selection of the load balancing system from among multiple load balancing systems is also based on packet priority.

15. An apparatus comprising:
a memory that is to store instructions and
a processor that is to execute the instructions to:
change from a first load balancer among multiple load balancers to select a second load balancer among the multiple load balancers based on a change in load metrics, wherein the multiple load balancers comprise at least: a load balancer that selects a processor core among the multiple processor cores based on a hash calculation, a processor-executed load balancer that load balances among the multiple processor cores based on the load metrics, and a load balancer circuitry that load balances among the multiple processor cores based on the load metrics.

16. The apparatus of claim 15, comprising the second load balancer communicatively coupled to the processor.

17. The apparatus of claim 15, wherein the load metrics comprise one or more of: packet receive rate, load balancer queue depth, or packet processing duration.

18. The apparatus of claim 17, wherein:
the load balancer queue depth comprises a number of packets to be allocated to processors cores by a load balancer, and
the packet processing duration comprises a time to complete processing of packets.

19. The apparatus of claim 15, wherein:
the first load balancer comprises the load balancer that selects the processor core among the multiple processor cores based on a hash calculation and
the second load balancer comprises the processor-executed load balancer that load balances among the multiple processor cores based on the load metrics or the load balancer circuitry that load balances among the multiple processor cores based on the load metrics.

20. The apparatus of claim 15, wherein:
the first load balancer comprises the processor-executed load balancer that load balances among the multiple processor cores based on the load metrics and
the second load balancer comprises the load balancer circuitry that load balances among the multiple processor cores based on the load metrics.
